(19) United States
(12) Patent Application Publication
(10) Pub. No.: US 2022/0403302 A1
(43) Pub. Date: Dec. 22, 2022

(54) FILM

(71) Applicant: CONOPCO, INC., D/B/A UNILEVER, Englewood Cliffs, NJ (US)

(72) Inventor: Girish MURALIDHARAN, Bangalore (IN)

(21) Appl. No.: 17/628,763

(22) PCT Filed: Jul. 27, 2020
(86) PCT No.: PCT/EP2020/071149

§ 371 Date: Jan. 20, 2022

(30) Foreign Application Priority Data
Jul. 30, 2019 (IN) 201921030723
Sep. 17, 2019 (EP) 19197695.0

(51) Int. Cl. C11D 17/04; C11D 11/00

(52) U.S. Cl. CPC C11D 17/043; C11D 11/0017; C11D 11/0023

(57) ABSTRACT

A dissoluble film comprising a slip agent wherein said film has biased distribution of the slip agent towards one surface of the film.

The present invention relates to a film, in particular, a film suitable for enclosing a unit dose product for laundering.

WO 01/64421 (Pvaxx Technologies Ltd.) discloses capsules formed from polyvinyl alcohol composition by blow moulding. Such capsules are suitable for containing pharmaceuticals or consumables or other substances like detergent. It is a viable alternative to gelatine for bio-degradable capsules. It further discloses a blow moulding apparatus suitable for forming such capsules.

JP 2017-119853 (Nippon Synthetic Chem Co Ltd.) discloses a water-soluble film containing polyvinyl alcohol resin with an α-surface on one side and a β-surface on another side has a dynamic friction coefficient of 0.290 to 0.650 measured when the α-surface is brought into contact with the β-surface. It further discloses that the film shows anti-blocking properties and causes no winding deviation in a film roll. The film is suitable for a unit packaging application including various medicines.

Despite the prior art, there remains a need for improved films particularly for enclosing unit dose products.

Accordingly, and in a first aspect, there is provided a dissoluble film comprising a slip agent wherein said film has biased distribution of the slip agent towards one surface of the film.

In a laundry context a unit dose product is a dose of detergent enclosed in a dissoluble film for one-time use. In use, a consumer deposits the product in water and optionally agitates to form a wash liquor. In another scenario, the consumer places the product directly into a washing machine such that the washing machine forms the wash liquor during the washing cycle.

Dissoluble films are prone to transfer water from inside of a unit dose product to the exterior or vice versa. This may affect the structural integrity of the unit dose product. For example, in case of an aqueous detergent, water may egress through the film and lead to collapse of the product. It is also possible that water enters the unit dose product from ambient and the unit dose product becomes overly stretched.

One way to avoid such a scenario is to incorporate a slip agent into the composition of the film. The slip agent reduces water transfer through the film. However, the slip agent migrates to both surfaces of the film making it incapable of heat sealing to form a unit dose product. Therefore, it is desirable that the film should reduce transfer of water and at the same time be useful for preparing a unit dose product by heat sealing.

We have surprisingly found that a film having biased distribution of a slip agent towards one surface reduces water transfer through the film and can still be used for enclosing unit dose products by heat sealing.

The present invention provides a film comprising a slip agent for enclosing a unit dose product. The film is characterised by biased distribution of the slip agent towards one surface of the film.

Typically, a film is made from a polymeric blend by homogenously mixing a polymer with additives and casting it to form a film. The term additive refers to the ingredients added to the film for various functional benefits and it includes plasticiser, slip agent, dyes, pigments and gustative deterrents.

The film according to the present invention comprises a slip agent. The slip agent is added to the polymeric blend as an additive in the process of making the film. Upon casting, the slip agent migrates from the polymer matrix towards surfaces of the film. This results in formation of layer of slip agent on each surface. In a conventional process, there is no control over the migration, thereby it migrates evenly to both surfaces of the film. We have found that films having evenly distributed slip agent towards both surfaces are not heat sealable from either of the surfaces and hence, cannot be used for enclosing unit dose products.

In the present invention, for casting the film, the polymer blend comprising the slip agent is disposed on a substrate such a way that only one surface of the film is in contact with the air. This causes migration of the slip agent towards the surface exposed to air resulting in biased distribution of the slip agent in the film. Surprisingly, the film, even though having the slip agent, remains heat sealable and can be used for enclosing unit dose products.

Preferably the film comprises 2.0 to 25% wt. of a slip agent. The slip agent is used in the film for blocking transfer of water through the film. Preferably the slip agent is present at from 3.0 to 20% wt. more preferably 4.0 to 15% wt. of the film.

Preferably, the slip agent is selected from C10 to C30 fatty acid amide. More preferably, the slip agent is selected from C8 to C22 fatty acid amides, even more preferably C12 to C22 fatty acid amides. Preferably, the fatty acid amide is saturated or unsaturated. Where it is unsaturated it is preferred that it is mono- or di-, more preferably mono-unsaturated.

Preferred slip agents include stearamide, erucamide and oleamide and mixture thereof.

Preferred slip agents are C18 to C22 mono-unsaturated fatty acid amides and include erucamide and oleamide.

Preferably the film comprises a dissoluble material such as polyvinyl alcohol (PVA) or a derivative thereof. The hydrolysed content and molecular weight of polyvinyl alcohol has impact on solubility and so is selected according to desired performance. In an embodiment the film thickness varies from 20 to 100 micrometre or preferably from 25 to 80 micrometre or more preferably from 30 to 60 micrometre.

Preferably the polyvinyl alcohol is present at from 50 to 98% wt. of the film. More preferably the polyvinyl alcohol is present at from 60 to 95% wt., even more preferably 70 to 90% wt. of the film. Preferably the film comprises a plasticiser. Preferably the plasticiser is present at from 0.1 to 25% wt. of the film. More preferably the plasticiser is present at from 0.5 to 20% wt., even more preferably at from 1.0 to 15% wt. of the film. Suitable plasticiser includes glycerol and sorbitol.

Preferably the film comprises a gustative deterrent. Gustative deterrents are known in the art and include denatonium salts such as chloride, benzoate and saccharide; trichloro anisole, benzoic benzylamine amide, methyl anthranilate, quinine and mixtures thereof.

Preferably, the film is printed to provide information to the consumer. The film may be printed on one or both sides depending on the need. In certain product formats it is preferred that the print is on the exterior of the product while on others it is preferred that it is on the interior surface of the film. Preferably, the print comprises a UV curable ink.

Accordingly, and in a second aspect, there is provided a method for forming a unit dose product for laundering comprising taking a water-soluble film according to the first aspect, forming a pouch with the film, filling the pouch with a laundry detergent and sealing the pouch by heating.

Preferably the method for forming a unit dose product includes, forming the pouch either by a form-fill-seal mechanism or forming a base with a single layer of film, drawing the film into a recess of a mould, filling the recess with composition, covering with another layer of film and then sealing.

Accordingly, and in a third aspect, there is provided a unit dose product contained within a water-soluble film according to the first aspect. Preferably the unit dose product is a laundry treatment product such as a laundry main wash product, a laundry ancillary product or laundry conditioning product. Preferably the unit dose product is a liquid detergent product.

Liquid Detergent Composition:

The liquid detergent composition may be any type of cleaning composition for which it is desirable to provide a dose thereof in a water-soluble unit dose product. Suitable detergent compositions may be used in the present invention include those intended for laundry (fabric cleaning, softening and/or treatment) or dishwashing. Preferred are laundry compositions, particularly laundry cleaning compositions.

In an embodiment, a unit dose product may be a multi-compartment product, where the product comprises more than one compartments containing the detergent composition.

In another scenario, the multi compartment unit dose product comprises different parts of a detergent composition which, when combined, make up the full detergent composition. This means that the formulation of each of the parts of the detergent composition is different either in its physical form (e.g. viscosity), its composition or its colour. Sometimes it will be sufficient to only have minor differences between the parts of the detergent composition e.g. colour, perfume etc. However, it will be advantageous to have visible differences.

The compartment or compartments of the unit dose product may comprise sequestrants, enzymes, bleach catalysts, perfume, builders etc.

Preferably the viscosity of the liquid detergent composition or parts of the liquid detergent composition is in the range 100 to 1000 cP.

The liquid detergent composition in each of the compartments preferably has a low water content of less than 50% wt., more preferably from 0.5 to 40% wt. water, most preferably from 1.0 to 27% wt.

However, while it is usual for compositions encapsulated in films to have a low level of water, perhaps around 1.0 to 10% wt. of the composition, the film used may permit the employment of higher water content films such as those using up to 40% wt. and as high as 50% wt. water.

Surfactant:

The detergent composition may comprise one or more surfactants. Many suitable detergent compounds are available and are fully described in the literature, for example, in “Surface-Active Agents and Detergents”, Volumes I and II, by Schwartz, Perry and Berch. The surfactant may be anionic (soap or non-soap), cationic, zwitterionic, amphoteric, non-ionic or mixture of two or more of these. The preferred surfactants are mixtures of soap, synthetic non-soap anionic and non-ionic surfactants optionally with amphoteric surfactant.

Anionic surfactant may be present in an amount from 0.5 to 50% wt, preferably from 2% wt. or 4% wt. up to 30% wt. or 40% wt. of the detergent composition. Suitable examples include alkyl benzene sulphonates, particularly sodium linear alkyl benzene sulphonates having an alkyl chain length of C5 to C15; olefin sulphonates; alkane sulphonates; dialkyl sulphosuccinates; and fatty acid ester sulphonates.

Suitable non-ionic surfactant compounds include in particular the reaction products of compounds having a hydrophobic group and a reactive hydrogen atom, for example, aliphatic alcohols, acids, amides or alkyl phenols with alkylene oxides, especially ethylene oxide. Specific non-ionic surfactant compounds are alkyl (C8 to C22) phenol-ethylene oxide condensates, the condensation products of linear or branched aliphatic C8 to 20 primary or secondary alcohols with ethylene oxide, and products made by condensation of ethylene oxide with the reaction products of propylene oxide and ethylene-diamine.

In a fabric washing detergent composition, these surfactants preferably comprise 5 to 50% wt. of the detergent composition. In a machine dishwashing composition, surfactant is likely to constitute from 0.5 to 8% wt. of the detergent composition and preferably consists of non-ionic surfactant, either alone or in a mixture with anionic surfactant.

Builders and Sequestrants:

The detergent composition may contain a so-called detergency builder which serves to remove or sequester calcium and/or magnesium ions in the water. Soluble builder may be added to the liquid composition. For example, sodium citrate or a soluble sequestrant, for example, Dequest 2066, which may also assist with stabilising the liquid.

The builder or sequestrant material is preferably fully soluble so as to eliminate the possibility of unwanted and unsightly residues on fabrics. For that reason, alkali metal aluminosilicates are not favoured.

Non-phosphorus water-soluble detergency builders may be organic or inorganic. Inorganic builders that may be present include alkali metal (generally sodium) carbonate; while organic builders include polycarboxylate polymers, such as polyacrylates, acrylic/maleic copolymers, and acrylic phosphonates, monomeric polycarboxylates such as citrates, gluconates, oxydisuccinates, glycerol mono- di and tri-succinates, carboxy methyl oxy-succinates, carboxy methyl oxy-malonates, dipicolinates and hydroxy ethyl iminodiacetates. Electrolytes such as sodium carbonate are not preferred due to the way they suppress the solubility of polyvinyl alcohol.

Bleach System:

The detergent composition may contain a bleach system. This preferably consists of an air bleaching catalyst. For example, the catalyst being a ligand of the formula (I) complexed with a transition metal, selected from Fe(II) and Fe(III),

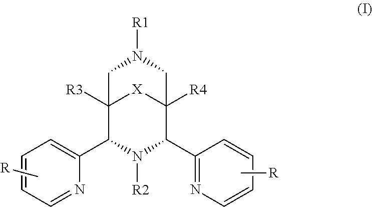

Where R1 and R2 are independently selected from:

C1 to C4 alkyl,

C6 to C10 aryl and,

a group containing a heteroatom capable of coordinating to a transition metal, wherein at least one of R1 and R2 is the group containing the heteroatom; preferably at least one of R1 or R2 is pyridin-2-ylmethyl. More preferably the catalyst is one in which R1 is pyridin-2-ylmethyl. Most preferably R1 is pyridin-2-ylmethyl and R2 is methyl;

R3 and R4 are independently selected from hydrogen, C1 to C8 alkyl, C1-C8-alkylene-O—C1-C8-alkyl, C1-C8-alkylene-O—C6-C10-aryl, C6 to C10 aryl, C1 to C8 hydroxyalkyl, and —(CH2)ₙC(O)OR5;

wherein R5 is independently selected from: hydrogen, C1 to C4 alkyl, n is from 0 to 4, and mixtures thereof; preferably R3=R4=—C(O)OMe and,

each R is independently selected from: hydrogen, F, Cl, Br, hydroxyl, C1-C₄-alkyO—, —NH—CO—H, —NH—CO—C1-C₄-alkyl, —NH2, —NH—C1-C₄-alkyl, and C1-C4-alkyl; preferably each R is hydrogen,

X is selected from C═O, —[C(R6)2]y- wherein Y is from 0 to 3, preferably 1, each R6 is independently selected from hydrogen, hydroxyl, C1-C4-alkoxy and C1-C4-alkyl preferably X is C═O.

Most preferably the catalyst is ([Fe(N2py3o)Cl]Cl) with structure (II):

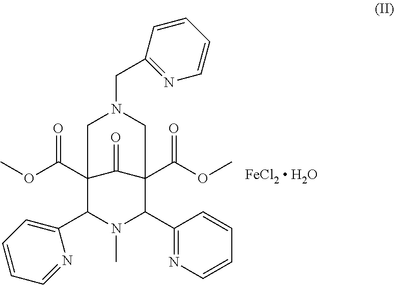

Also known as Iron(1+), chloro[rel-1,5-dimethyl (1R,2S,4R,5S)-9,9-dihydroxy-3-methyl-2,4-di(2-pyridinyl-kN)-7-[(2-pyridinyl-kN)methyl]-3,7-diazabicyclo[3.3.1]nonane-1,5-dicarboxylate-kN3, kN7]-, chloride (1:1), (OC-6-63)[CAS Registry Number 478945-46-9].

To avoid possible gassing of ingredients it is preferred to avoid the use of per salt or per-acid bleaching species in the unit dose products.

Further Optional Ingredients:

Detergency enzymes may be employed in the compositions.

The composition may also contain a fluorescer (optical brightener), for example, Tinopal (trademark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2-bis-(phenylstyryl) disulphonate.

An antifoam material may be included when surfactant is present; especially if the detergent composition is primarily intended for use in front-loading drum-type automatic washing machines. Soap is a suitable antifoam.

Further ingredients which can optionally be employed in laundry detergent composition of the invention include anti-redeposition agents such as sodium carboxymethylcellulose, straight-chain polyvinyl pyrrolidone and the cellulose ethers such as methyl cellulose and ethyl hydroxyethyl cellulose, fabric-softening agents; perfumes; and colorants or coloured speckles.

Use of Unit Dose Products:

The unit dose products described herein are suitable for use in a cleaning method, suitably a laundry method. Preferably the method includes placing the unit dose product in the drum of a washing machine prior to commencement of a wash cycle.

The unit dose products are particularly suitable for use in (fabric) washing machines and in dishwashing machines amongst other applications. They can also be used in manual laundry and dishwashing operations. In use the unit dose products according to the invention are preferably, and conveniently, placed directly into the water which will form the wash liquor or into the area where this water will be introduced. The unit dose product dissolves on contact with the water, thereby releasing the detergent composition from the compartments and allowing them to form the desired wash liquor.

It is a particular advantage of the unit dose products that they may alternatively be placed into a dispensing drawer of the type found in automatic laundry washing machines where water flows through the drawer.

Accordingly, and in a fourth aspect, there is provided a use of a film according the first aspect for enclosing a solid detergent product. Preferably the film is used as a primary packaging for enclosing a solid detergent. The term primary packaging refers to a packaging directly in contact with the product. Preferably the primary packaging helps in increasing shelf life of the detergent by reducing moisture ingression from surrounding into the product. Preferably the solid detergent product is a detergent bar.

Accordingly, and in a fifth aspect, there is provided a method for forming a film according to the first aspect comprising adding a slip agent to a film forming polymer; mixing the polymer and slip agent blend homogenously; casting the blend to form the film by depositing the blend on a substrate such a way that only one surface of the film is in contact with the air; and setting said blend to form the film. Preferably the film forming polymer is a dissoluble polymer such as polyvinyl alcohol or derivative thereof.

### EXAMPLES

The film formulation details are as follows:

TABLE 1

| Ingredient | Formulation |
|---|---|
| Polyvinyl alcohol (% w/w) | 85.7 |
| Plasticizer (% w/w) | 8.6 |
| Erucamide (% w/w) | 5.7 |

TABLE 2

| | Film A | Film 1 |
|---|---|---|
| Distribution | Symmetric | Biased |
| of slip agent | distribution | distribution |

Film 1 is the film according to invention and film A is a comparative. Symmetric distribution refers to a distribution where the slip agent is evenly migrated towards both surfaces of the film.

The following process may be followed to make a dissolvable film:

The hydrolysed content and molecular weight of polyvinyl alcohol affect solubility of it. The compositions were prepared by using a polyvinyl alcohol mixture containing 98% hydrolysed polyvinyl alcohol of molecular weight 31-50K and 88% hydrolysed polyvinyl alcohol of molecular weight 85-124K in 4:1 ratio (by weight).

At first, 1.5 g poly vinyl alcohol mixture was added to 37.5 millilitre water to make an aqueous solution. The mixture was heated to 80° C., with stirring at 300 rpm until homogeneous solution is achieved. To the above mixture, 0.15 g plasticizer (PEG-Mw 200) was added, mixed for 5 minutes, and cooled down to room temperature.

In parallel, 1.5 g erucamide was dissolved in 15 ml isopropyl alcohol (IPA) (or ethanol or any organic solvent) and heated to 50° C. The solution remains homogenous even after cooling. One ml of the 10% erucamide solution (equivalent to 0.1 g of erucamide) was added to the polymer resin after cooling, and mixing is continued. This yields 5.7% wt. of erucamide in the composition.

For biased distribution, pour the solution to a clean-dry petri dish and keep it in oven under 60° C. for 8 hrs for drying.

Alternatively, erucamide also can be added without IPA, by direct addition of powder, however we need to homogenize the solution at 60° C. rather than room temperature.

The following process was followed for heat sealing the films:

The film was heat sealed using commercial heat-sealing machine (Plastic film sealer). The observations are summarized in below table.

TABLE 3

| Effect | Film A | Film 1 |
|---|---|---|
| Heat sealable | No | Yes |

From the examples it is evident that that a film comprising slip agent and having biased distribution of the slip agent can be heat sealed and so be used for enclosing unit dose products. Where the slip agent is distributed evenly to both opposing surfaces of the film, the product cannot be heat sealed and so cannot be used to form unit dosed products.

1. A unit dose product, wherein the unit dose product is contained in a water-dissoluble film, the film comprises 2.0 to 25% wt. of a slip agent and the film has biased distribution of the slip agent towards one surface of the film.

2. The unit dose product of claim 1 wherein the film comprises polyvinyl alcohol.

3. The unit dose product of claim 2 wherein the polyvinyl alcohol is present at from 50% to 98% wt. of the film.

4. The unit dose product of claim 1 wherein the slip agent is selected from C10 to C30 fatty acid amides.

5. The unit dose product of claim 4 wherein the C10 to C30 fatty acid amide is unsaturated.

6. The unit dose product of claim 1 wherein the slip agent is selected from erucamide, oleamide and stearamide and mixtures thereof.

7. The unit dose product of claim 1 wherein the film comprises 0.1 to 25% plasticiser.

8. The unit dose product of claim 1 wherein the film comprises a gustative deterrent.

9. The unit dose product of claim 1 wherein the product is a laundry treatment product.

10. The unit dose product of claim 1 wherein the product is a liquid detergent product.

11. The unit dose product of claim 1 wherein the product is a dishwash product.

12. A method for forming a unit dose product for laundering, the method comprising:
taking a film, wherein the film comprises 2.0 to 25% wt. of a slip agent and the film has biased distribution of the slip agent towards one surface of the film;
forming a pouch with the film;
filling the pouch with a laundry detergent; and
sealing the pouch by heating.

13. The method of claim 12 wherein the film comprises polyvinyl alcohol.

14. The method of claim 13 wherein the polyvinyl alcohol is present at from 50% to 98% wt. of the film.

15. The method of claim 12 wherein the slip agent is selected from C10 to C30 fatty acid amides.

16. The method of claim 15 wherein the C10 to C30 fatty acid amide is unsaturated.

17. The method of claim 12 wherein the slip agent is selected from erucamide, oleamide and stearamide and mixtures thereof.

18. The method of claim 12 wherein the film comprises a gustative deterrent.

19. The method of claim 12 wherein the product is a laundry treatment product.

20. The method of claim 12 wherein the product is a liquid detergent product.
